(19) United States
(12) Patent Application Publication
(10) Pub. No.: US 2024/0126927 A1
(43) Pub. Date: Apr. 18, 2024

(54) UI/UX DEVELOPMENT SYSTEM APPLIED WITH BLOCKCHAIN FOR PREVENTING FORGERY/FALSIFICATION AND FORGERY/FALSIFICATION VERIFICATION METHOD USING THE SAME

(71) Applicant: SHIFT INFORMATION & COMMUNICATION. CO. LTD., Seongnam-si (KR)

(72) Inventors: Daegeun Lim, Namyangju-si (KR); Jeongmu Yoon, Seoul (KR)

(73) Assignee: SHIFT INFORMATION & COMMUNICATION. CO. LTD., Seongnam-si (KR)

(21) Appl. No.: 17/966,899

(22) Filed: Oct. 17, 2022

(51) Int. Cl. G06F 21/64; G06F 8/38; G06F 21/60; G06Q 20/36

(52) U.S. Cl. CPC G06F 21/64; G06F 8/38; G06F 21/602; G06Q 20/36

(57) ABSTRACT

The UI/UX development system applying the blockchain for preventing forgery/falsification according to the present disclosure includes a UI/UX client 100 provided with a browser that shows a web page screen, a UI/UX server 200 configured to perform an operation according to a request of the UI/UX client 100 by being connected to the UI/UX client 100 through a network and include a blockchain linkage module 500 that links at least some of information related to the web page screen transmitted from the UI/UX client 100 with a blockchain, a database 300 connected to the UI/UX server 200, and a blockchain log DB 400 that is linked with the UI/UX server 200, is configured to store blockchain linkage information linked with the blockchain among the information related to the web page screen, and is connected to the UI/UX server 200.

### BACKGROUND

The present disclosure relates to a UI/UX development system applying a blockchain for preventing forgery/falsification and a forgery/falsification verification method using the same.

Blockchain technology, which has emerged as one of core technologies of the 4th industrial revolution, has the characteristic that it is possible to verify the authenticity and forgery/falsification of information stored in a block, and it is impossible to arbitrarily manipulate or delete specific records.

For this reason, there is a strong will to utilize the strengths of blockchain by introducing the blockchain technology in various industries. However, applying the blockchain technology to the legacy system already in use has a high degree of impact on the existing system, and thus there is a problem that not only is it difficult to try to apply the blockchain technology, but it is also difficult to find successful cases.

Recently, as the blockchain issue is emerging worldwide and the global blockchain market is expected to grow more than 10 times in the next five years, the demand for the application of blockchain technology in the global IT development field is increasing significantly. However, so far, even in the global market including the United States, the supply of blockchain technology application is limited to a group of experts in contrast to the general demand which is rapidly increasing. Resultantly, there is no suitable solution in the market that makes it easier to apply the blockchain technology to various task systems of companies or institutions.

Even in Korea, while the social/institutional necessity for blockchain, which is the main core technology of the 4th industrial revolution, is emerging centered on the central government departments, and the demand for application by institutions is rapidly increasing. However, it is also in an environment where, from a programming point of view, the level of understanding of institutional IT developers about the blockchain technology is low, and from a practical application point of view, it is also not easy to apply blockchain technology.

Further, from a technical point of view, in an operation of a task system of a company or institution, measures to enhance and improve the transparency, reliability, safety, and security of a service system from the threat of forgery/falsification, hacking, and information manipulation by insiders by preventing falsification of information are required.

In other words, a technology-based service for proving the transparency of all reports in an internal management system in response to data manipulation problems related to personnel/purchase/bidding corruption is needed, and measures to prevent forgery/falsification of major document data due to intentional DB change by the insiders are needed.

If there is no such preventative measure, the problem of attacking by changing a web client source for the purpose of arbitrarily falsifying data or acquiring desired data by intentionally bypassing user authentication or by bypassing session inspection, etc. may occur. Therefore, it is necessary to develop a security technology to verify whether the web client source has been changed and to neutralize a request through web client source manipulation.

### SUMMARY

The present disclosure provides a UI/UX development system applying a blockchain for preventing forgery/falsification and forgery/falsification verification method using the same by recognizing the above problems and necessity.

In accordance with an exemplary embodiment of the present invention, a UI/UX development system applying a blockchain for preventing forgery/falsification comprises a UI/UX client 100 provided with a browser that shows a web page screen, a UI/UX server 200 configured to perform an operation according to a request of the UI/UX client 100 by being connected to the UI/UX client 100 through a network and include a blockchain linkage module 500 that links at least some of information related to the web page screen transmitted from the UI/UX client 100 with a blockchain, a database 300 connected to the UI/UX server 200, and a blockchain log DB 400 that is linked with the UI/UX server 200, is configured to store blockchain linkage information linked with the blockchain among the information related to the web page screen, and is connected to the UI/UX server 200.

The UI/UX client 100 may be configured to include a UI/UX integrated development environment (IDE) 120 including a UI component 122 for developing the web page screen.

The UI/UX integrated development environment (IDE) 120 may be configured to include a blockchain linkage template 124 for defining at least some of the information related to the web page screen as the blockchain linkage information.

The blockchain linkage module 500 may be configured to include an integrated log management unit 510 configured to manage the blockchain linkage information, a blockchain service unit 520 configured to link the blockchain linkage information with the blockchain, and a blockchain management unit 530 configured to manage the linked blockchain.

The integrated log management unit 510 may be configured to include a hash module 512 configured to generate a hash value based on the blockchain linkage information, a log storage module 514 configured to store the blockchain linkage information in the blockchain log DB 400, and a verification module 516 configured to verify whether or not verification target information transmitted from the UI/UX client 100 is forged/falsified, based on the hash value.

The blockchain service unit 520 may be configured to include a blockchain interface 522 for storing the hash value generated by the hash module 512 in the blockchain.

The blockchain may be a public blockchain or a private blockchain.

The blockchain is a public blockchain, and the blockchain service unit 520 may be configured to include a wallet management module 524 configured to store the blockchain in which the hash value is stored in a virtual wallet and manage an access right and private key to the virtual wallet and an exchange module 526 for a blockchain transaction.

The blockchain management unit 530 may be configured to include a monitoring module 532 configured to monitor information related to an operation performed by the blockchain service unit 520, and a user right management module 534 configured to manage user rights of the UI/UX client 100.

The blockchain linkage information may be logging information for which history information including at least one of at least a partial area of a web page screen developed using the UI/UX development system, transaction data related to the web page screen, and an attached file is a logging target.

In accordance with another exemplary embodiment of the present invention, a web page forgery/verification method using a UI/UX development system applying a blockchain comprises transmitting, by the UI/UX client 100, blockchain linkage information linked with a blockchain among information related to the web page screen to the UI/UX server 200, generating, by the UI/UX server 200, a first hash value based on the blockchain linkage information received from the UI/UX client 100, storing, by the UI/UX server 200, the first hash value in the blockchain, storing, by the UI/UX server 200, the blockchain linkage information and a blockchain storage location TX-ID of the blockchain in which the first hash value is stored together in a blockchain log DB 400, generating, by the UI/UX server 200, a second hash value using the blockchain linkage information stored in the blockchain log DB 400 when the UI/UX server 200 receives a return request for the blockchain linkage information from the UI/UX client 100, and receiving, by the UI/UX server 200, the first hash value as a return value using the blockchain storage location TX-ID stored in the blockchain log DB 400, and comparing the first hash value with the second hash value to verify whether or not the blockchain linkage information is forged/falsified.

The forgery/falsification verification method may include defining logging information for which history information, which comprises at least one of at least a partial area of a web page screen developed using the UI/UX development system, transaction data related to the web page screen, and an attached file, is a logging target, as the blockchain linkage information.

In the storing, by the UI/UX server 200, of the blockchain linkage information and the blockchain storage location TX-ID of the blockchain in which the first hash value is stored together in the blockchain log DB 400, log data consisting of a unique identifier KEY, a time displacement parameter Timestamp, the logging target, the blockchain storage location TX-ID, and the logging information is stored in the blockchain log DB 400.

The UI/UX server 200 may determine that the blockchain linkage information is not forged/falsified when the first hash value and the second hash value are the same as each other, and determine that the blockchain linkage information is forged/falsified when the first hash value and the second hash value are different from each other, and transmit forgery/falsification check information to the UI/UX client 100.

In accordance with still another exemplary embodiment of the present invention, a web page forgery/verification method using a UI/UX development system applying a blockchain comprises transmitting, by the UI/UX client 100, a reference hash value of the web page screen to the UI/UX server 200 as the blockchain linkage information, storing, by the UI/UX server 200, the reference hash value received from the UI/UX client 100 in a blockchain, transmitting, by the UI/UX server 200, the web page to the UI/UX client 100 when the UI/UX server 200 receives a request for the web page from the UI/UX client 100, inquiring/updating, by the UI/UX client 100, the received web page, generating, by the UI/UX client 100, a verification target hash value by combining a received hash value of the web page screen, a session key, and an input item of the web page screen and transmitting the verification target hash value and the input item to the UI/UX server 200, generating, by the UI/UX server 200, a hash value for verification by combining the reference hash value stored in the blockchain, a current session key, and the input item, and verifying, by the UI/UX server 200, whether or not the web page is forged/falsified by comparing the verification target hash value and the hash value for verification.

### BRIEF DESCRIPTION OF THE DRAWINGS

Exemplary embodiments can be understood in more detail from the following description taken in conjunction with the accompanying drawings, in which:

FIG. 1 is a conceptual diagram illustrating a UI/UX development system applying a blockchain in accordance with an embodiment of the present invention;

FIG. 2 is a block diagram illustrating a configuration of the UI/UX development system of FIG. 1;

FIG. 3 is a conceptual diagram illustrating the configuration of the UI/UX development system of FIG. 1 and an interconnection relationship between the components thereof;

FIG. 4 is a flowchart illustrating a first embodiment of a web page forgery/falsification verification method using the UI/UX development system of FIG. 1;

FIG. 5 is a conceptual diagram illustrating a configuration of log data stored in a blockchain log DB of the UI/UX development system of FIG. 1;

FIG. 6 is a block diagram illustrating a configuration of a conventional UI/UX development system.

### DETAILED DESCRIPTION OF EMBODIMENTS

Hereinafter, a UI/UX development system according to the present invention will be described with reference to the accompanying drawings.

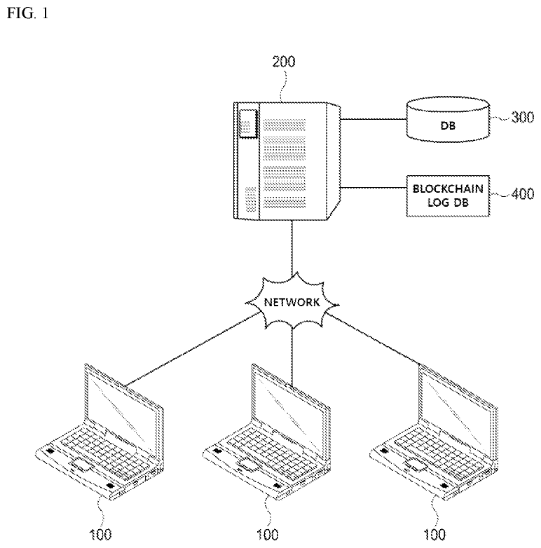

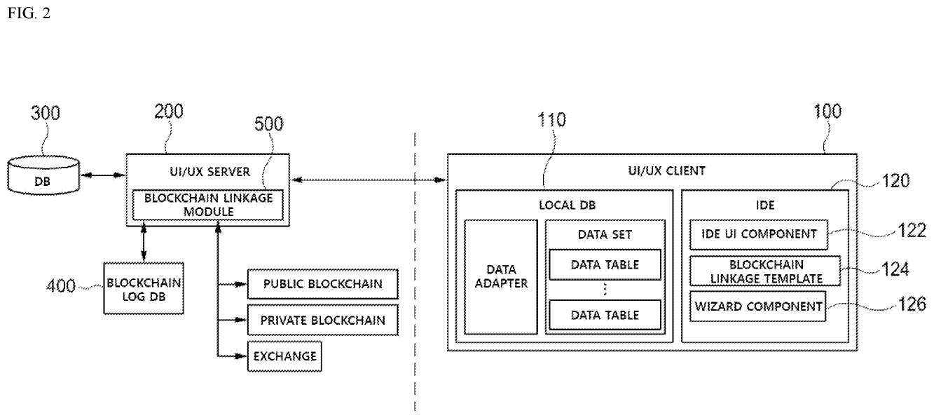

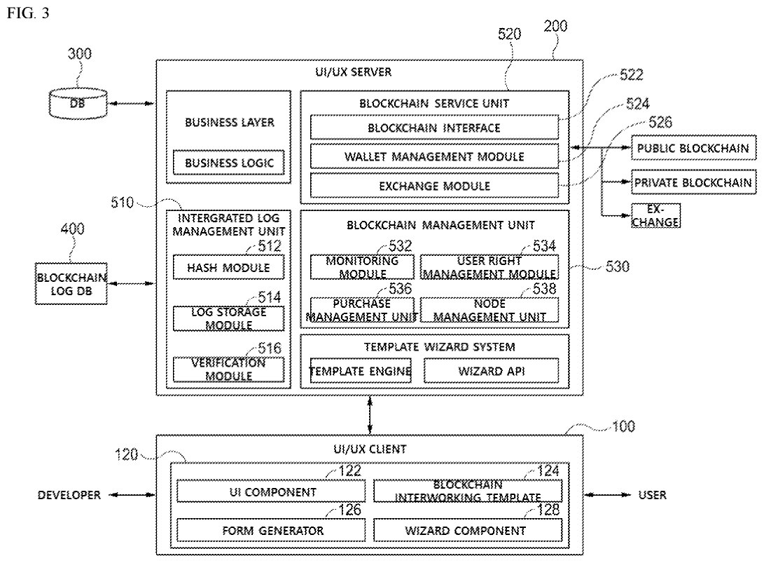

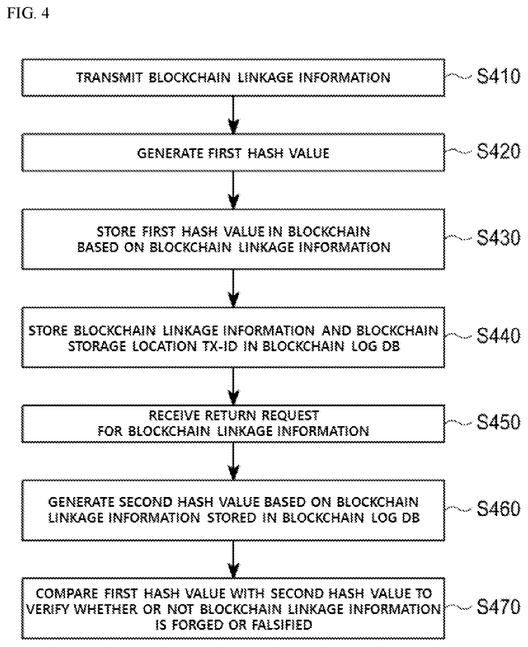

The UI/UX development system according to the present invention is a UI/UX development system applying a blockchain for preventing forgery/falsification, as illustrated in FIGS. 1 to 6, and includes a UI/UX client 100 provided with a browser that shows a web page screen, a UI/UX server 200 that performs an operation according to a request of the UI/UX client 100 by being connected to the UI/UX client 100 through a network and includes a blockchain linkage module 500 that links at least some of information related to the web page screen transmitted from the UI/UX client 100 with a blockchain, a database 300 connected to the UI/UX server 200, and a blockchain log DB 400 that is linked with the UI/UX server 200, stores blockchain linkage information linked with the blockchain among the information related to the web page screen, and is connected to the UI/UX server 200.

The UI/UX development system according to the present disclosure is a solution that enables web-based development of all tasks of a company or institution regardless of the type of task, and may be, for example, a web standard HTML5 UI/UX development and operating solution.

The UI/UX client 100 corresponds to a computing device connected with the UI/UX server 200 to be described later through a network, may be implemented as, for example, a desktop, a laptop computer, a tablet PC, or a smartphone, and may include a network interface for network connection with the UI/UX server 200 and a user input/output interface for user input/output.

As an example, the UI/UX client 100 may correspond to a mobile terminal, and may be connected to the UI/UX server 200 through cellular communication or Wi-Fi communication.

As another example, the UI/UX client 100 may correspond to a desktop computer, and may be connected to the UI/UX server 200 through the Internet.

The UI/UX client 100 may be provided with a browser that shows a developed web page screen.

The UI/UX client 100 may include a UI/UX integrated development environment 120 for web-based UI/UX development, and a source code of the web page screen (e.g., source code written in a language such as HTML, Java Script, etc.) may be created/modified/changed through the UI/UX integrated development environment 120.

UI/UX development through the UI/UX client 100 may be implemented through the UI/UX integrated development environment (IDE) 120, which provides an environment that handles all tasks related to UI/UX development, such as coding, debugging, and compilation, in one program.

In addition, the UI/UX integrated development environment (IDE) 120 can provide a development environment of a WISIWIG (what you see is what you get) method, and may be implemented to be compatible with all browsers, operating systems (OSs) and devices by supporting multi-browser/multi-device/multi-platform.

Meanwhile, the UI/UX integrated development environment (IDE) 120 may include a UI component 122 for developing the web page screen.

The UI component 122 may be a component for input items and control of the web page screen, such as drop-down list, list box, combo box, radio button, check box, toggle button, slider, etc. on the web page screen.

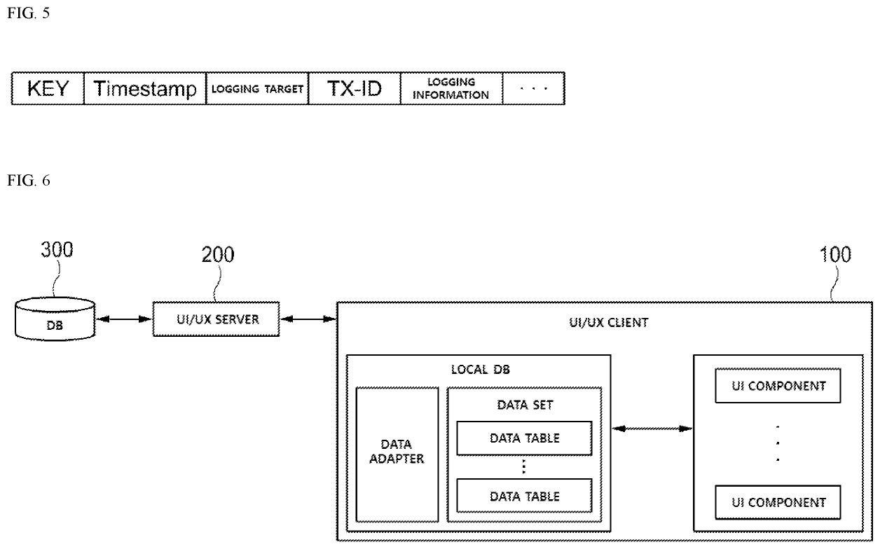

The conventional UI/UX development system provides only the UI component 122 for web page screen development in a UI/UX client end (front end), as illustrated in FIG. 6, but the UI/UX integrated development environment (IDE) 120 according to the present disclosure may further include a blockchain linkage template 124 for defining at least some of information related to the web page screen as blockchain linkage information.

The blockchain linkage template 124 is a template for defining at least some of the information related to the developed web page screen as the blockchain linkage information, and may be provided in various ways depending on the type of task to be developed.

For example, the blockchain linkage template 124 is a standardized template format for each industry sector/task target, and may be supported by various formats, such as recruitment evaluation, bid evaluation, various contracts, and accounting books.

At least some of the information related to the web page screen developed through the blockchain linkage template 124 may be defined as blockchain linkage information linked with the blockchain.

For example, the blockchain linkage information may be logging information for which history information including at least one of at least a partial area (specific area image) of the web page screen developed using the UI/UX development system of the present disclosure, transaction data related to the web page screen, and an attached file is a logging target.

As another example, the blockchain linkage information may be a source code (e.g., HTML, Java Script, etc.) constituting the screen of the web page developed using the UI/UX development system of the present invention and a unique hash value of the web page screen.

In this case, the UI/UX integrated development environment (IDE) 120 may generate a template format of the blockchain linkage template 124 selected by the UI/UX client 100 through a form generator 126.

Further, the UI/UX integrated development environment (IDE) 120 may further include a WIZARD component 128 for setup for blockchain linkage through the blockchain linkage template 124.

The UI/UX server 200 is a server that is connected to the UI/UX client 100 through a network and performs an operation according to the request of the UI/UX client 100, and may include a processor, a memory, a storage device, a network interface, a user interface input device, and a user interface output device.

The processor may include a program executor and a memory manager for UI/UX development and operation.

The memory manager may manage memory areas in the memory that are read or written by the program executor.

The storage device may be implemented as a non-volatile memory such as a solid state disk (SSD) or a hard disk drive (HDD), and may be used to store data required for the UI/UX server 200.

The network interface includes an environment for connecting to the UI/UX client 100 through a network, and may include, for example, an adapter for local area network (LAN) communication.

The UI/UX server 200 may include a blockchain linkage module 500 that links at least some of the information related to the web page screen transmitted from the UI/UX client 100 with the blockchain.

Here, the information linked with the blockchain by the blockchain linkage module 500 may be the blockchain linkage information defined by the UI/UX client 100.

The blockchain linkage module 500 is a configuration that links the information defined as the blockchain linkage information among the information related to the web page screen transmitted from the UI/UX client 100 with the blockchain, and can be configured in various ways.

For example, the blockchain linkage module 500 may include an integrated log management unit 510 that manages the blockchain linkage information, a blockchain service unit 520 that links the blockchain linkage information with the blockchain, and a blockchain management unit 530 that manages the linked blockchain.

The integrated log management unit 510 may include a hash module 512 that generates a hash value based on the blockchain linkage information received from the UI/UX client 100, a log storage module 514 that stores the blockchain linkage information in the a blockchain log DB 400 to be described later, and a verification module 516 that verifies whether or not verification target information transmitted from the UI/UX client 100 is forged/falsified based on the hash value.

The hash module 512 is a configuration that generates a hash value based on the blockchain linkage information, and can be configured in various ways.

Specifically, the hash module 512 may generate the hash value by combining the blockchain linkage information and a time displacement parameter Timestamp associated with the blockchain linkage information.

The log storage module 514 is a configuration that stores the blockchain linkage information in the blockchain log DB 400 to be described later, and can be configured in various ways.

Here, the log storage module 514 may store log data including the blockchain linkage information and the time displacement parameter Timestamp in the blockchain log DB 400 to be described later.

The log data may be configured to include a unique identifier KEY, the time displacement parameter Timestamp, a logging target of blockchain link information, a blockchain storage location TX-ID, and logging information (blockchain linkage information), as illustrated in FIG. 5.

Here, the blockchain storage location TX-ID is a transaction hash of the blockchain, and may be defined as a blockchain unique ID in which the hash value generated by the hash module 512 is stored.

The verification module 516 is a configuration that verifies whether or not the verification target information transmitted from the UI/UX client 100 is forged/falsified, based on the hash value generated by the hash module 512, and can be configured in various ways.

The configuration and actions of the verification module 516 will be described in detail together with the web page forgery/falsification verification method to be described later.

The blockchain service unit 520 may include a blockchain interface 522 for storing the hash value generated by the hash module 512 in the blockchain.

The blockchain interface 522 is an interface configured so to be linkable with the blockchain in order to store the hash value generated by the hash module 512 in the blockchain, and can be configured in various ways.

When the hash value is stored in the blockchain, the blockchain storage location TX-ID of the blockchain is returned to the UI/UX server, and may be stored (updated) in the blockchain log DB to be described later in the form of log data through the log storage module 514.

Here, the blockchain is a distributed data storage technology based on distributed computing technology in which data called ‘blocks’ are stored in a chain-type link-based distributed data storage environment created based on the P2P method, so that anyone cannot arbitrarily modify the block and anyone can read the result of the change.

In other words, the blockchain has the characteristic that it is possible to verify the authenticity and forgery/falsification of the information stored in the ‘block’, and it is impossible to arbitrarily manipulate or delete specific records.

The blockchain linked through the blockchain interface 522 may be a public blockchain (e.g., Bitcoin, Ethereum, etc.) or a private blockchain (e.g., Hyperledger, etc.).

When the blockchain is a public blockchain, the blockchain service unit 520 may include a wallet management module 524 that stores the blockchain in which the hash value is stored in a virtual wallet and manages an access right and private key to the virtual wallet, and an exchange module 526 for a blockchain transaction.

The wallet management module 524 is a configuration that manages the access right and private key to the public blockchain, and can be configured in various ways.

The exchange module 526 is an interface for the blockchain transaction, and is a configuration for a transaction (purchase) through an exchange of the public blockchain and can be configured in various ways.

The blockchain management unit 530 may include a monitoring module 532 that monitors information related to the operation performed by the blockchain service unit 520 and a user right exchange management module 534 that manages user rights of the UI/UX client 100.

The monitoring module 532 is a configuration for monitoring the information related to the operation performed by the blockchain service unit 520, and may provide a dashboard enabling monitoring by aggregating data information on the blockchain linkage service performed by the blockchain service unit 520.

The user right management module 534 is a configuration for managing user rights of the UI/UX client 100, and may be configured to manage access rights to the blockchain service unit 520 of the UI/UX client 100.

In addition, the blockchain management unit 530 may further include a purchase management unit 536 that manages the balance or transaction (purchase) history of the blockchain (managing deposit and withdrawal of blockchain), and a node management unit 538 that manages nodes of the blockchain.

Meanwhile, the UI/UX server may include a template engine for providing a requested blockchain linkage template 124 to the UI/UX client 100, and a wizard API for setup for blockchain linkage through the blockchain linkage template 124.

The database 300 is a data aggregate connected to the UI/UX server and may be managed through a database management system.

The blockchain log DB 400 is a log system that is connected to the UI/UX server 200 and stores the blockchain linkage information, and can be configured in various ways.

The data stored in the blockchain log DB 400 may be log data including the blockchain linkage information, as illustrated in FIG. 6.

The blockchain storage location TX-ID of the log data is returned to the UI/UX server from the blockchain where the hash value generated based on the blockchain linkage information is stored, and may be stored (or updated) in the blockchain log DB 400 in a log data format through the log storage module 514.

In the blockchain log DB 400, data is encrypted for its own security, or the blockchain log DB 400 may be separated for each task or organization on the development system, and access rights for each task or organization may be set differently.

Hereinafter, the web page forgery/falsification verification method using the UI/UX development system including the configuration described above will be described in detail.

In one embodiment, the web page forgery verification method may include a blockchain linkage information transmission step S410 of transmitting, by the UI/UX client 100, blockchain linkage information linked with a blockchain among information related to the web page screen to the UI/UX server 200, a first hash value generation step S420 of generating, by the UI/UX server 200, a first hash value based on the blockchain linkage information received from the UI/UX client 100, a blockchain storage step S430 of storing, by the UI/UX server 200, the first hash value in the blockchain, a blockchain log DB storage step S440 of storing, by the UI/UX server 200, the blockchain linkage information and a blockchain storage location TX-ID of the blockchain in which the first hash value is stored together in the blockchain log DB 400, a second hash value generation step S460 of generating, by the UI/UX server 200, a second hash value using the blockchain linkage information stored in the blockchain log DB 400, when the UI/UX server 200 receives a return request for the blockchain linkage information from the UI/UX client 100 (S450), and a forgery/falsification verification step S470 of receiving, by the UI/UX server 200, the first hash value as a return value using the blockchain storage location TX-ID stored in the blockchain log DB 400, and comparing the first hash value with the second hash value to verify whether or not the blockchain linkage information is forged/falsified.

In the blockchain linkage information transmission step S410, the UI/UX client 100 may transmit the blockchain linkage information linked with the blockchain among the information related to the web page screen to the UI/UX server 200.

In this case, the forgery/falsification verification method may include a blockchain linkage information definition step of defining logging information for which history information, which includes at least one of at least a partial area of a web page screen developed using the UI/UX development system, transaction data related to the web page screen, and an attached file, is a logging target, as the blockchain linkage information.

The first hash value generation step S420 is a step of generating, by the UI/UX server 200, the first hash value based on the blockchain linkage information received from the UI/UX client 100, and may be performed in the hash module 512 of the UI/UX server 200.

The hash module 512 may generate the first hash value by combining the blockchain linkage information and the time displacement parameter Timestamp associated with the blockchain linkage information.

The blockchain storage step S430 is a step of storing, by the UI/UX server 200, the first hash value in the blockchain, and may be performed by the blockchain interface 522 of the UI/UX server 200.

In this case, the blockchain storage location TX-ID of the blockchain in which the first hash value is stored may be returned to the UI/UX server 200.

The blockchain log DB storage step S440 is a step of storing, by the UI/UX server 200, the blockchain linkage information and the blockchain storage location TX-ID of the blockchain in which the first hash value is stored together in the blockchain log DB 400, and may be performed by the log storage module 514 of the UI/UX server 200.

In this case, the log storage module 514 may store log data including the unique identifier KEY, the time displacement parameter Timestamp, the logging target of blockchain link information, the blockchain storage location TX-ID, and the logging information (blockchain linkage information) in the blockchain log DB 400.

The second hash value generation step S460 is a step of generating, by the UI/UX server 200, a second hash value using the blockchain linkage information stored in the blockchain log DB 400 when the UI/UX server 200 receives a return request for the blockchain linkage information from the UI/UX client 100 (S450), and may be performed by the hash module 512 of the UI/UX server 200.

More specifically, the hash module 512 may generate the second hash value by combining the blockchain linkage information and the time displacement parameter Timestamp associated with the blockchain linkage information that are included in the log data using the log data stored in the blockchain log DB 400.

The forgery/falsification verification step S470 is a step of receiving, by the UI/UX server 200, the first hash value as a return value using the blockchain storage location TX-ID stored in the blockchain log DB 400 and comparing the first hash value with the second hash value to verify whether or not the blockchain linkage information is forged/falsified, and may be performed by the verification module 516 of the UI/UX server.

The first hash value is a hash value stored in the blockchain, and may be returned to the UI/UX server 200 using the blockchain storage location TX-ID included in the log data of the blockchain log DB 400.

The verification module 516 may compare the first hash value with the second hash value and determine that the blockchain linkage information (verification target information) requested by the UI/UX client 100 is not forged/falsified when the first hash value and the second hash value are the same as each other, and may compare the first hash value with the second hash value, and determine that the blockchain linkage information (verification target information) requested by the UI/UX client 100 is forged/falsified when the first hash value and the second hash value are different from each other.

The UI/UX server 200, specifically, the verification module 516 may determine that the blockchain linkage information is not forged/falsified when the first hash value and the second hash value are the same as each other, determine that the blockchain linkage information is forged/falsified when the first hash value and the second hash value are different from each other, and transmit forgery/falsification check information to the UI/UX client 100.

Here, the UI/UX client 100 may be a user client.

In the web page forgery/falsification verification method according to the embodiment, it is possible to check whether or not the data associated with the web page screen has been manipulated or changed, by utilizing the integrity characteristics of the blockchain, it is possible to verify whether or not a result value displayed on the current screen of the UI/UX client 100 is forged/falsified. Accordingly, the web page forgery/falsification verification method according to the embodiment can be applied to various task services that require data forgery/falsification prevention, such as contracts, bidding, recruitment, various public services, finance, medical care, content, logistics, distribution, etc.

In another embodiment, the web page forgery/falsification verification method may include a blockchain linkage information transmission step S510 of transmitting, by the UI/UX client 100, a reference hash value of the web page screen to the UI/UX server 200 as the blockchain linkage information, a blockchain storage step S520 of storing, by the UI/UX server 200, the reference hash value received from the UI/UX client 100 in a blockchain, a web page transmission step S530 of transmitting, by the UI/UX server 200, the web page to the UI/UX client 100 when the UI/UX server 200 receives a request for the web page from the UI/UX client 100, a web page inquiry/update step S540 of inquiring/updating, by the UI/UX client 100, the received web page, an input information transmission step S550 of generating, by the UI/UX client 100, a verification target hash value by combining a received hash value of the web page screen, a session key, and an input item of the web page screen and transmitting the verification target hash value and the input item to the UI/UX server 200, a hash value for verification generation step S560 of generating, by the UI/UX server 200, a hash value for verification by combining the reference hash value stored in the blockchain, a current session key, and the input item, and a forgery/falsification verification step S570 of verifying, by the UI/UX server 200, whether or not the web page is forged/falsified by comparing the verification target hash value and the hash value for verification.

The blockchain linkage information transmission step S510 is a step of transmitting, by the UI/UX client 100, the reference hash value of the web page screen to the UI/UX server 200 as the blockchain linkage information, and may include a blockchain linkage information definition step of defining, by the UI/UX client 100, the reference hash value of the web page screen as the blockchain linkage information.

Here, the reference hash value may be a unique hash value of the web page screen that has been developed using the UI/UX development system, and the UI/UX client 100 may be a developer client.

In the blockchain linkage information transmission step S510, a screen configuration (e.g., the source code constituting the screen of a web page (e.g., HTML, Java Script, etc.)) of the developed web page and the reference hash value may be transmitted together to the UI/UX server 200.

The blockchain storage step S520 is a step of storing, by the UI/UX server 200, the reference hash value received from the UI/UX client 100 in the blockchain, and may be performed by the blockchain interface 522 of the UI/UX server 200.

When the UI/UX server 200 receives a request for a web page from the UI/UX client 100, the UI/UX server 200 may transmit the web page to the UI/UX client 100.

Here, the UI/UX client 100 may be a user client.

The web page inquiry/update step S540 is a step of inquiring/updating the web page received from the UI/UX client 100. In the web page inquiry/update step S540, the web page received from the browser of the UI/UX client 100 may be inquired/updated.

In the input information transmission step S550, by the UI/UX client 100, the verification target hash value may be generated by combining the received hash value of the web page screen, the session key, and the input item of the web page screen and the verification target hash value and the input item may be transmitted to the UI/UX server 200.

The verification solution generation step S560 is a step of generating, by the UI/UX server 200, the hash value for verification by combining the reference hash value stored in the blockchain, the current session key, and the input item, and may be performed by the hash module 512 of the UI/UX server 200.

The forgery/falsification verification step S570 is a step of verifying, by the UI/UX server 200, whether or not the web page inquired by the UI/UX client 100 is forged/falsified by comparing the verification target hash value with the verification solution hash value, and may be performed by the verification module 516 of the UI/UX server 200.

The UI/UX server 200, specifically, the verification module 516, in the forgery/falsification verification step S570, may determine that the web page inquired by the UI/UX client 100 is a flawless web page that has not been forged/falsified when the verification target hash value and the verification solution hash value are the same as each other, and may determine that the web page inquired by the UI/UX client 100 is forged/falsified when the verification target hash value and the verification solution hash value are different from each other, thereby capable of verifying whether the web page is forged/falsified.

The UI/UX server 200, specifically, the verification module 516, in the forgery/falsification verification step S570, may determine that the web page inquired/updated by the UI/UX client 100 is not forged/falsified when the verification target hash value and the verification solution hash value are the same as each other, determine that the web page inquired/updated by the UI/UX client 100 is forged/falsified when the verification target hash value and the verification solution hash value are different from each other, and transmit forgery/falsification check information to the UI/UX client 100.

In the web page forgery/falsification verification method according to the embodiment, when the UI/UX client 100 requests a data inquiry or update to the server through a web page, it is possible to check the integrity of information for which the data inquiry or update to the server is requested from the UI/UX client 100 and verify whether or not there is any falsification of the web page by referring to the reference hash value stored in the blockchain.

In particular, in the web page forgery/falsification verification method according to the embodiment, it is possible to block in advance malicious user actions for the purpose of changing or acquiring server information through source code falsification on the web page by storing and utilizing the unique hash value (reference hash value) of the developed web page in the blockchain.

Since the matters described above has only been described with respect to some of the preferred embodiments that can be implemented by the present invention, as noted, the scope of the present invention should not be construed as being limited to the above examples. The technical idea of the present invention described above and the technical idea with the root thereof should be construed as being included in the scope of the present invention.

The UI/UX development system applying a blockchain according to the present invention and the web page forgery/falsification verification method using the same has the advantage of being able to easily introduce the blockchain into a task system of a company or institution by applying the blockchain to the UI/UX development system without changing the existing legacy system.

Specifically, the UI/UX development system applying the blockchain according to the present invention and the web page forgery/falsification verification method using the same have the advantage of being able to verify data forgery/falsification, such as unauthorized data acquisition/update through manipulation of input data and forgery/falsification of a web page source code, without affecting the existing legacy system by including a blockchain log DB that stores blockchain linkage information linked with the blockchain among information related to a web page, which is developed using a UI/UX development system for developing a web page screen for web-based work of an institution or a company, separately from the existing database (DB) and storing the hash value of the blockchain linkage information in the blockchain.

Although the UI/UX development system applying a blockchain for preventing forgery/falsification and the forgery/falsification verification method using the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A UI/UX development system applying a blockchain for preventing forgery/falsification, comprising:
a UI/UX client 100 provided with a browser that shows a web page screen;
a UI/UX server 200 configured to perform an operation according to a request of the UI/UX client 100 by being connected to the UI/UX client 100 through a network and include a blockchain linkage module 500 that links at least some of information related to the web page screen transmitted from the UI/UX client 100 with a blockchain;
a database 300 connected to the UI/UX server 200; and
a blockchain log DB 400 that is linked with the UI/UX server 200, is configured to store blockchain linkage information linked with the blockchain among information related to the web page screen, and is connected to the UI/UX server 200.

2. The system of claim 1, wherein
the UI/UX client 100 comprises a UI/UX integrated development environment (IDE) 120 including a UI component 122 for developing the web page screen.

3. The system of claim 2, wherein
the UI/UX integrated development environment (IDE) 120 comprises a blockchain linkage template 124 for defining at least some of the information related to the web page screen as the blockchain linkage information.

4. The system of claim 1, wherein
the blockchain linkage module 500 comprises
an integrated log management unit 510 configured to manage the blockchain linkage information,
a blockchain service unit 520 configured to link the blockchain linkage information with the blockchain, and
a blockchain management unit 530 configured to manage the linked blockchain.

5. The system of claim 4, wherein
the integrated log management unit 510 comprises
a hash module 512 configured to generate a hash value based on the blockchain linkage information,
a log storage module 514 configured to store the blockchain linkage information in the blockchain log DB 400, and
a verification module 516 configured to verify whether or not verification target information transmitted from the UI/UX client 100 is forged/falsified based on the hash value.

6. The system of claim 5, wherein
the blockchain service unit 520 comprises a blockchain interface 522 for storing the hash value generated by the hash module 512 in the blockchain.

7. The system of claim 6, wherein
the blockchain is a public blockchain or a private blockchain.

8. The system of claim 6, wherein
the blockchain is a public blockchain, and
the blockchain service unit 520 comprises
a wallet management module 524 configured to store the blockchain in which the hash value is stored in a virtual wallet and manage an access right and private key to the virtual wallet, and
an exchange module 526 for a blockchain transaction.

9. The system of claim 6, wherein
the blockchain management unit 530 comprises
a monitoring module 532 configured to monitor information related to a work performed by the blockchain service unit 520, and
a user right management module 534 configured to manage user rights of the UI/UX client 100.

10. The system of claim 1, wherein
the blockchain linkage information is logging information for which history information including at least one of at least a partial area of a web page screen developed using the UI/UX development system, transaction data related to the web page screen, and an attached file is a logging target.

11. A a web page forgery/verification method using the UI/UX development system applying the blockchain according to claim 1, the method comprising:
transmitting, by the UI/UX client 100, blockchain linkage information linked with a blockchain among information related to the web page screen to the UI/UX server 200;
generating, by the UI/UX server 200, a first hash value based on the blockchain linkage information received from the UI/UX client 100;
storing, by the UI/UX server 200, the first hash value in the blockchain;
storing, by the UI/UX server 200, the blockchain linkage information and a blockchain storage location TX-ID of the blockchain in which the first hash value is stored together in a blockchain log DB 400;
generating, by the UI/UX server 200, a second hash value using the blockchain linkage information stored in the blockchain log DB 400 when the UI/UX server 200 receives a return request for the blockchain linkage information from the UI/UX client 100; and
receiving, by the UI/UX server 200, the first hash value as a return value using the blockchain storage location TX-ID stored in the blockchain log DB 400, and comparing the first hash value with the second hash value to verify whether or not the blockchain linkage information is forged/falsified.

12. The method of claim 11, further comprising:
defining logging information for which history information, which includes at least one of at least a partial area of a web page screen developed using the UI/UX development system, transaction data related to the web page screen, and an attached file, is a logging target, as the blockchain linkage information.

13. The method of claim 12, wherein
in the storing, by the UI/UX server 200, of the blockchain linkage information and the blockchain storage location TX-ID of the blockchain in which the first hash value is stored together in the blockchain log DB 400, log data consisting of a unique identifier KEY, a time displacement parameter Timestamp, the logging target, the blockchain storage location TX-ID, and the logging information is stored in the blockchain log DB 400.

14. The method of claim 11, wherein
the UI/UX server 200 is configured to determine that the blockchain linkage information is not forged/falsified when the first hash value and the second hash value are the same as each other, and determine that the blockchain linkage information is forged/falsified when the first hash value and the second hash value are different from each other, and transmit forgery/falsification check information to the UI/UX client 100.

15. A a web page forgery/verification method using the UI/UX development system applying the blockchain according to claim 1, the method comprising:
transmitting, by the UI/UX client 100, a reference hash value of the web page screen to the UI/UX server 200 as the blockchain linkage information;
storing, by the UI/UX server 200, the reference hash value received from the UI/UX client 100 in a blockchain;
transmitting, by the UI/UX server 200, the web page to the UI/UX client 100 when the UI/UX server 200 receives a request for the web page from the UI/UX client 100;
inquiring/updating, by the UI/UX client 100, the received web page;
generating, by the UI/UX client 100, a verification target hash value by combining a received hash value of the web page screen, a session key, and an input item of the web page screen and transmitting the verification target hash value and the input item to the UI/UX server 200;
generating, by the UI/UX server 200, a hash value for verification by combining the reference hash value stored in the blockchain, a current session key, and the input item; and
verifying, by the UI/UX server 200, whether or not the web page is forged/falsified by comparing the verification target hash value and the hash value for verification.
